(19) United States
(12) Patent Application Publication
(10) Pub. No.: US 2003/0059351 A1
(43) Pub. Date: Mar. 27, 2003

(54) Chemical reactor

(75) Inventors: Masanobu Awano, Aichi (JP); Yoshinobu Fujishiro, Aichi (JP); Hae Jin Hwang, Aichi (JP); Sergei Bredikhin, Aichi (JP); Kazuyuki Matsuda, Aichi (JP); Kunihiro Maeda, Aichi (JP); Takao Kanai, Aichi (JP); Motoyuki Miyata, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Inst. of Advanced Ind. Science and Tech., Tokyo (JP)

(21) Appl. No.: 10/198,357

(22) Filed: Jul. 19, 2002

(30) Foreign Application Priority Data
Jul. 24, 2001 (JP) 2001-223687

(51) Int. Cl. B01J 8/04

(52) U.S. Cl. 422/168; 422/171

(57) ABSTRACT

The present invention provides a chemical reactor for carrying out chemical reactions of substances to be treated in the presence of excess oxygen in which nitrogen oxides can be decomposed and removed with high efficiency and low energy consumption, wherein the catalytic reaction is utilized to reduce the content of excess oxygen during the chemical reactions.

### BACKGROUND OF THE INVENTION

1. Field of the Invention

The present invention relates to a chemical reactor (electrochemical cell) for carrying out chemical reactions of substances involving nitrogen oxides and other substances to be treated, and more particularly to a chemical reactor that allows, for example, nitrogen oxides to be decomposed and removed from oxygen-containing combustion exhaust gases with high efficiency and low power consumption even in the presence of excess oxygen, which impedes chemical reactions of substances to be treated.

2. Description of the Related Art

A method using three-way catalyst systems is primarily used for decomposing and removing the nitrogen oxides generated by gasoline engines. However, in lean-burning engines and diesel engines, with which increased mileage is possible, there is the problem of a sharp drop in the catalytic action due to the adsorption of oxygen on the surface of the three-way catalyst systems because of the presence of excess oxygen in the combustion exhaust gas, making it impossible to effectively remove nitrogen oxides.

On the other hand, by using a solid electrolyte film having oxygen ion conductivity through which a current is passed, the oxygen in the exhaust gas can be eliminated without being adsorbed on the catalyst surface. In addition, it has been reported that a system in which nitrogen oxides are broken down into oxygen and nitrogen simultaneously with the elimination of surface oxygen by the application of a voltage to a solid electrolyte sandwiched between electrodes has been proposed for a catalytic reactor.

References related to the aforementioned prior art are listed below.

J. Electrochemical Soc., 122, 869 (1975). This reference presents a system where platinum electrodes are formed on both sides of zirconia stabilized with scandium oxide, and nitrogen oxides are broken down into nitrogen and oxygen by the application of a voltage.

J. Chem. Soc. Faraday Trans., 91, 1995 (1995). This reference presents a system in which palladium electrodes are formed on both sides of yttria-stabilized zirconia, and the nitrogen oxides in a mixed gas of nitrogen oxides, hydrocarbons, and oxygen are broken down into nitrogen and oxygen by the application of a voltage.

However, in the aforementioned conventional methods, when excess oxygen is present in the combustion exhaust gas, the coexisting oxygen ionizes and flows through the solid electrolyte, so a large amount of current is required to flow in order to break down the nitrogen oxides. As a result, there is the problem that the power consumption increases and the development of a new technology without the aforementioned problem has been ardently sought in this field of technology.

With the foregoing in view and in order to solve the aforementioned problems, the present inventors embarked on research into the technological task of developing technology to reduce the amount of ionized oxygen that flows in the solid electrolyte when excess oxygen is present in a combustion exhaust gas, and hence developing a chemical reactor (electrochemical cell) in which the amount of current required to decomposition of the nitrogen oxides can be reduced and nitrogen oxides can be decomposed and removed with low power consumption and a high degree of efficiency.

### SUMMARY OF THE INVENTION

The present invention provides a chemical reactor in which nitrogen oxides can be decomposed and removed with high efficiency and low energy consumption in the presence of excess oxygen in combustion exhaust gas. A chemical reactor for carrying out chemical reactions of substances to be treated in the presence of excess oxygen, comprising a chemical reaction section in which the chemical reactions of the substances to be treated proceed, and a catalytic reaction section in which the oxygen concentration is reduced; and having a structure in which the catalytic reaction section is disposed in the upstream portion of the chemical reaction section, wherein the catalytic reaction is utilized to reduce the content of excess oxygen during the chemical reactions.

Specifically, as a result of repeated and painstaking research aimed at developing a new chemical reactor (electrochemical cell) in which nitrogen oxides can be decomposed and removed with high efficiency and low power consumption, the inventors perfected the present invention upon discovering that the substances to be treated can be treated with high efficiency and lower power consumption by employing a catalytic reaction to reduce the content of excess oxygen as harmful gas when the catalytic reaction section of the chemical reactor is disposed in the upstream portion of the chemical reaction section with respect to the flow of the gas to be treated, and the substances to be treated are caused to undergo a chemical reaction.

The present invention comprises the following technological means aimed at resolving the aforementioned issues.

(1) A chemical reactor for carrying out chemical reactions of substances to be treated in the presence of excess oxygen, comprising a chemical reaction section in which the chemical reactions of the substances to be treated proceed, and a catalytic reaction section in which the oxygen concentration is reduced; and having a structure in which the catalytic reaction section is disposed in the upstream portion of the chemical reaction section, wherein the catalytic reaction is utilized to reduce the content of excess oxygen during the chemical reactions.

(2) The chemical reactor according to the said (1), wherein the catalytic reaction section comprises an oxidation catalyst.

(3) The chemical reactor according to the said (1), wherein the chemical reaction section comprises a reduction phase for supplying electrons to the elements contained in the substances to be treated to generate ions; an ion-conducting phase for conducting the ions from the reduction phase; and an oxidation phase for releasing the electrons from the ions conducted by the ion-conducting phase.

(4) The chemical reactor according to the said (3), wherein the catalytic reaction section covers the surface of the reduction phase.

(5) The chemical reactor according to the said (4), wherein a porous oxidation catalyst film covers the surface of the reduction phase.

(6) The chemical reactor according to the said (4), wherein an electric insulating layer is disposed between the catalytic reaction section and the reduction phase.

(7) The chemical reactor according to the said (3), wherein the substances to be treated are nitrogen oxides, the nitrogen oxides are reduced in the reduction phase to generate oxygen ions, and the oxygen ions are conducted by the ion-conducting phase.

(8) The chemical reactor according to the said (1), wherein the oxygen concentration is reduced by means of a catalytic combustion reaction between the oxygen and a combustible gas in the catalytic reaction section.

### BRIEF DESCRIPTION OF THE DRAWINGS

FIG. 1 is a structural drawing of the chemical reactor related to an example of the present invention;

FIG. 2 is a cross-sectional view of one illustration of the chemical reactor shown in FIG. 1;

FIG. 3 is a cross-sectional view of the chemical reactor related to an example of the present invention; and

FIG. 4 is a cross-sectional view of the chemical reactor related to another example of the present invention.

### DESCRIPTION OF THE PREFERRED EMBODIMENTS

Next, a more detailed explanation will be given regarding the present invention.

The present invention is a chemical reactor (electrochemical cell) for carrying out chemical reactions such as decomposing and removing nitrogen oxides and other substances to be treated, comprising a chemical reaction section in which the chemical reactions of the substances to be treated proceed, and a catalytic reaction section (in other words, an oxygen partial pressure decreasing layer) whose function is to reduce the concentration of oxygen, which is an impediment to the chemical reactions, wherein the catalytic reaction section is disposed in the upstream portion of the chemical reaction section.

The chemical reaction section for performing the chemical reaction of substances to be treated should preferably comprise a reduction phase for supplying electrons to the elements contained in the substances to be treated to generate ions; an ion-conducting phase for conducting the ions from the reduction phase; and an oxidation phase for releasing the electrons from the ions conducted by the ion-conducting phase.

The nitrogen oxides contained in a combustion exhaust gas can be given as an example of such substances to be treated, and, in this case, the nitrogen oxides are reduced in the aforementioned reduction phase of the chemical reactor to generate oxygen ions, the oxygen ions are conducted by the ion-conducting phase, and the electrons are released from the ions in the oxidation phase. The substances to be treated of the present invention are not limited to nitrogen oxides and, as long as the substance is a gas that contains oxygen atoms, the same kind of treatment is possible. Carbon dioxide, methane, water (water vapor) and the like can be given as examples. In these cases, for example, the carbon dioxide can be reduced to generate carbon monoxide, a mixed gas of hydrogen and carbon monoxide can be generated from the methane, or hydrogen can be generated from the water by the chemical reactor of the present invention.

Tubular, flat, and honeycombed configurations can be cited as preferred examples of the shapes selected for the chemical reactor of the present invention. Particularly preferred among these are configurations in which a single continuous hole or a plurality of continuous holes having a pair of openings are provided, and a chemical reaction section is placed in each continuous hole, such as in the case of tubular and honeycombed configurations.

A porous phase capable of selectively adsorbing the substance to be subjected to a chemical reaction is preferred for the reduction phase of the chemical reaction section. The reduction phase should preferably comprise an electroconductive substance in order to supply electrons to the elements contained in the substances to be treated, to generate ions, and to transfer the generated ions to the ion-conducting phase. In addition, to promote the transfer of electrons and ions, it is preferable that the reduction phase comprise a mixed-conductivity substance having both the properties of electron conductivity and ion conductivity, or comprise a mixture of an electron-conducting substance and an ion-conducting substance. The reduction phase may also comprise a structure having as many as two or more layered phases of these substances.

The electroconductive substances and ion-conducting substances used for the aforementioned reduction phase are not particularly restricted. Examples of such electroconductive substances include precious metals such as platinum, palladium and the like, and metal oxides such as nickel oxide, cobalt oxide, copper oxide, lanthanum manganite, lanthanum cobaltite, lanthanum chromite, and the like. Barium-containing oxides, zeolite, and other materials capable of selectively adsorbing substances to be treated can also be used for the reduction phase. Furthermore, the use of a mixture of at least one type of the aforementioned substances and at least one type of ion-conducting substance is preferable. Zirconia stabilized with yttria or scandium oxide, ceria stabilized with gadolinium oxide or samarium oxide, lanthanum gallate, or the like can be used for the ion-conducting substance. It is also preferable that the reduction phase comprise a structure having at least two layered phases of the aforementioned substances. It is even more preferable that the reduction phase comprise a two-phase layered structure having a electroconductive substance phase comprising a precious metal such as platinum, and a mixture phase of nickel oxide and zirconia stabilized with yttria or scandium oxide.

The ion-conducting phase should comprise an ion-conducting solid electrolyte, and preferably a solid electrolyte capable of conducting oxygen ions. Zirconia stabilized with yttria or scandium oxide, ceria stabilized with gadolinium oxide or samarium oxide, and lanthanum gallate can be given as examples of solid electrolytes capable of conducting oxygen ions, but no particular restrictions are imposed. Zirconia stabilized with yttria or scandium oxide, which possess high conductivity, strength, and superior long-term stability, should preferably be employed for the ion-conducting phase.

The oxidation phase contains an electroconductive substance in order to release the electrons from the ions in the ion-conducting phase. In order to promote the transfer of electrons and ions, it is preferable that the oxidation phase comprise a mixed-conductivity substance having both the properties of electron conductivity and ion conductivity, or comprise a mixture of an electron-conducting substance and an ion-conducting substance. The electroconductive substances and the ion-conducting substances that can be used for the oxidation phase are not particularly restricted. Precious metals such as platinum, palladium and the like, and metal oxides such as nickel oxide, cobalt oxide, copper oxide, lanthanum manganite, lanthanum cobaltite, lanthanum chromite, and the like can be employed for the electroconductive substance. For example, zirconia stabilized with yttria or scandium oxide, ceria stabilized with gadolinium oxide or samarium oxide, or lanthanum gallate can be used as the ion-conducting substance.

The catalytic reaction section (oxygen partial pressure decreasing layer) comprises an oxidation catalyst for initiating a catalytic combustion reaction between, for example, the excess oxygen and combustible gas present in combustion exhaust gas. Precious metals and metal oxides can, for example, be employed as the oxidation catalyst, and there are no particular restrictions. Metal oxides having a perovskite structure such as lanthanum manganite and metal oxides having a pyrochlore structure possess high oxidation activity at high temperatures and are inexpensive compared to precious metals, and should therefore be preferably used as the oxidation catalyst. In addition, strontium-substituted lanthanum manganite has even higher oxidation activity, and is therefore even more preferable.

It is important for the chemical reactor of this invention thus configured that, for example, a contaminated combustion exhaust gas pass through the chemical reaction section after passing through the catalytic reaction section; that is, that the catalytic section be disposed in the upstream portion of the chemical reaction section with respect to the gas flow. In this case, forming the catalytic reaction section by covering the reduction phase that comprises the chemical reaction section with the oxidation catalyst phase is more preferable because the substances to be treated can be efficiently treated with a smaller amount of oxidation. It is also more preferable that the reduction phase that comprises the chemical reaction section be covered with an electrical insulating phase, and the catalytic reaction section be formed by covering the insulating phase with an oxidation catalyst phase, in order to prevent the catalytic reaction section from acting as a reduction phase. By this means, it is possible to securely prevent the oxidation catalyst phase from acting as a reduction phase.

Insulating substances such as alumina, silica, and glass can be used for forming the electrical insulating phase. It is preferable that the electrical insulating phase be porous to allow the substances to be treated passing through the catalytic reaction section to reach the reduction phase.

The oxidation catalyst may, for example, be in the form of powder or film The catalytic reaction section can be configured by filling a vessel having a gas inlet/outlet with a powder. In addition, an item in which the oxidation catalyst powder is carried on a tubular or honeycombed carrier surface, and the oxidation catalyst is formed as a porous-film on the carrier surface, can be employed as the catalytic reaction section. An arrangement in which the oxidation catalyst is configured as a porous film on the reduction phase constituting the chemical reaction section is particularly preferred for the catalytic reaction section. Since the number of catalytic reaction sites increases with an increase in the area of contact with the substances to be treated, it is preferable that the relative surface area of the oxidation catalyst phase be maximized and that the particles constituting the oxidation catalyst powder and the oxidation catalyst film be as fine as possible.

The present invention relates to a chemical reactor for carrying out chemical reactions such as decomposing and removing nitrogen oxides and other substances to be treated from oxygen-containing combustion exhaust gas, comprising a chemical reaction section in which the chemical reactions of the substances to be treated proceed, and a catalytic reaction section (oxygen partial pressure decreasing layer) for decreasing the oxygen concentration, wherein the catalytic reaction section is disposed in the upstream portion of the chemical reaction section. A particular feature of this chemical reactor is that the reduction phase constituting the chemical reaction section is covered by a porous oxidation catalyst film, and when a chemical reaction of the substances to be treated is carried out, the content of excess oxygen, which is an impediment to the chemical reaction, is reduced by utilizing the catalytic reaction, making it possible to ionize the coexisting oxygen and to reduce the flow that passes through the solid electrolyte of the chemical reactor. By this means, the amount of current required for the chemical reaction of the substances to be treated is reduced and the substances to be treated can be treated with high efficiency and low power consumption.

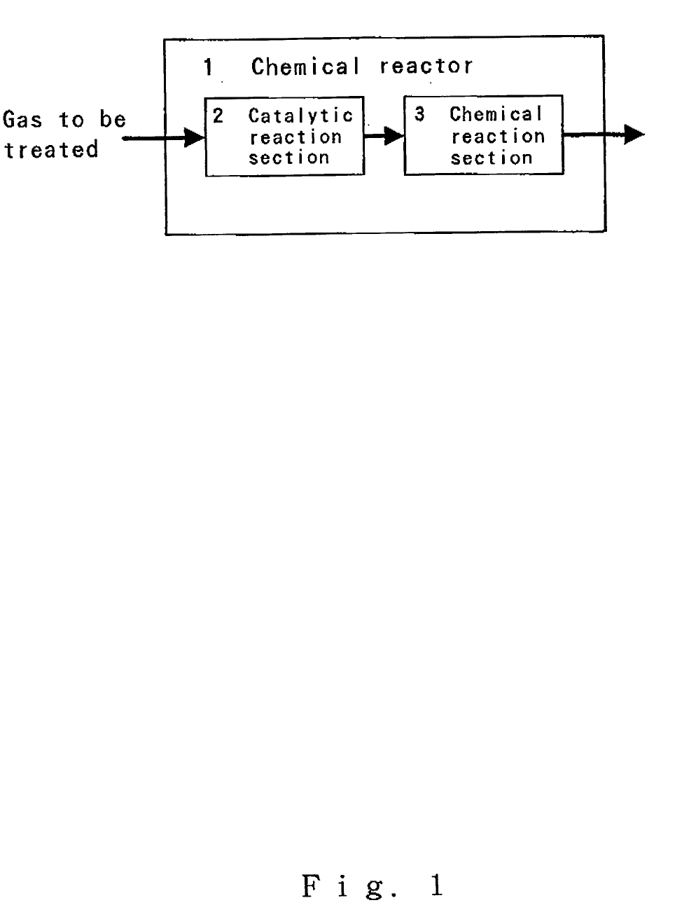

Next, an explanation will be given of the present invention based on the drawings. FIG. 1 is a structural drawing of the chemical reactor 1 related to an example of the present invention. The chemical reactor (electrochemical cell) comprises a catalytic reaction section 2 and a chemical reaction section 3, and the catalytic reaction section 2 is placed in the upstream portion of the chemical reaction section 3 with respect to the flow of the gas to be treated. In other words, the gas to be treated passes through the chemical reaction section 3 after passing through the catalytic reaction section 2.

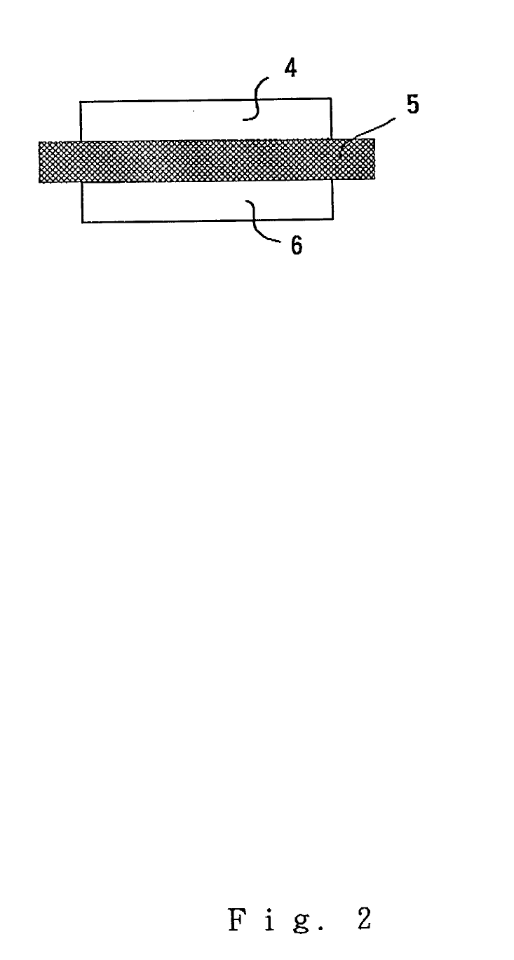

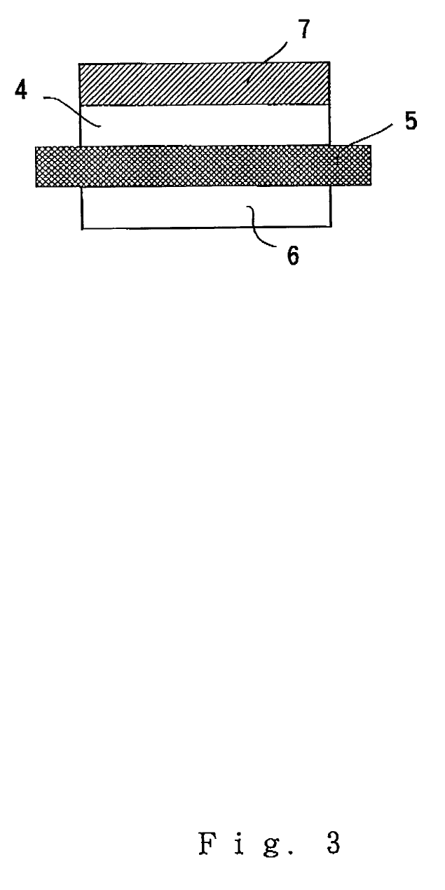

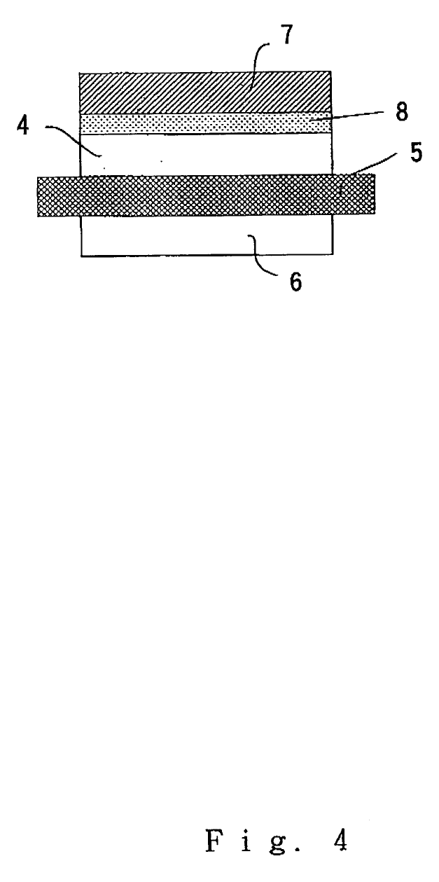

FIG. 2 shows a cross-sectional view of the structure of the chemical reaction section 3 related to the present invention. A reduction phase 4 is formed on one of the surfaces of an ion-conducting solid electrolyte 5, and an oxidation phase 6 is formed on the other surface. FIG. 3 shows the reduction phase 4 of the chemical reaction section 3 covered by the catalytic reaction section composed of an oxidation catalyst phase 7. FIG. 4 shows an electrical insulation phase 8 formed between the reduction phase 4 and the oxidation catalyst phase 7 of the chemical reaction section 3.

### EXAMPLES

Next, a concrete explanation of the present invention will be given with reference to a case in which nitrogen oxides are used as substances to be treated.

### Example 1

(1) Fabrication of Chemical Reactor

Yttria-stabilized zirconia was employed as an ion-conducting phase composed of an ion-conducting solid electrolyte 5 constituting a chemical reaction section 3. The Yttria-stabilized zirconia was shaped as a disk with a diameter of 20 mm and a thickness of 0.5 mm. In addition, the reduction phase 4 constituting the chemical reaction section 3 had a two-layer structure that consisted of a platinum film and a film composed of a mixture of nickel oxide and yttria-stabilized zirconia. The platinum film was formed by a method in which one side of a solid electrolyte 5 was screen-printed to obtain a surface area of about 1.8 cm², and the product was heat-treated at 1200° C. The mixed film of nickel oxide and yttria-stabilized zirconia was formed by a method in which the platinum film was screen-printed to obtain the same surface area as the platinum film, and the product was heat-treated at 1450° C. The mixing ratio (molar ratio) of nickel oxide and yttria-stabilized zirconia was 6:4. The platinum film was subsequently screen-printed such that a surface area of about 1.8 cm² was obtained on the other surface of the solid electrolyte 5 on which the reduction phase had been formed, and the product was heat-treated at 1200° C., yielding an oxidation phase 6.

An La₁—ₓSrₓMnO_{3-δ} powder (where x=0.25) (referred to as “LSM” hereinbelow), which is a perovskite oxide, was used as the oxidation catalyst comprising the catalytic reaction section 2. A quartz tube was filled with the LSM powder, a catalytic reaction section was formed by disposing the tube in the upstream portion of the chemical reaction section 3, and a chemical reactor was fabricated. As is shown in FIG. 1, the gas introduced into the chemical reactor 1 for processing passes through the chemical reaction section 3 after passing through the catalytic reaction section 2.

(2) Removal of Nitrogen Oxides

Nitrogen oxides were removed using the inventive chemical reactor formed in this manner. The treatment method is presented next. The chemical reactor 1 was placed in the gas to be treated, platinum wires were fixed as leads to the reduction phase 4 and oxidation phase 6, the system was connected to a DC power source, a DC voltage was applied, and a current was passed. The evaluation was carried out in the reaction temperature range of 500-600° C. A model combustion exhaust gas of helium balance having 1000 ppm nitrogen monoxide, 2% oxygen, and 0.3% hydrocarbons was passed at a flow rate of 50 ml/min as the gas to be treated. The concentration of nitrogen oxides in the gas to be treated was measured with a chemiluminescence NOx meter before and after the chemical reactor, and the nitrogen and oxygen concentrations were measured by gas chromatography. The removal rate of nitrogen oxides was derived from the reduction in nitrogen oxides, and the current density and power consumption were measured when the removal rate became 50%.

(3) Results

The chemical reactor was heated to a reaction temperature of 600° C. and the electricity was turned on to the chemical reaction section. The removal rate of nitrogen oxides increased together with the increase in the amount of the current at this time, and the content of nitrogen oxides decreased to about 50% when the current density was 43.9 mA/cm² and the power consumption was 87 mW. The oxygen concentration in the gas at the outlet of the chemical reactor at this time had been lowered to about 1%.

### Example 2

A chemical reactor was fabricated in the same manner as in Example 1 except that La₁₋ₓCeₓSn_{1-y}Mn_{y}O_{7-δ} (where x and y=0.2) (referred to as “LCSM hereinbelow), which is a pyrochlore oxide, was used as the oxidation catalyst constituting the catalytic reaction section. The chemical reactor was heated to a reaction temperature of 600° C. and the electricity was turned on to the chemical reaction section. The content of nitrogen oxides decreased this time to about 50% when the current density was 44.4 mA/cm² and the power consumption was 88 mW. The oxygen concentration in the gas at the outlet of the chemical reactor at this time had been lowered to about 1%.

### Example 3

The chemical reactor was prepared with the catalytic reaction section 2 made by forming an LCSM film as the oxidation catalyst phase 7 such that the film covered the surface of the reduction phase 4 of the chemical reaction section 3, which was prepared in the same manner as in Example 1. The cross-sectional structure of this chemical reactor is shown in FIG. 3. The chemical reactor was heated to a reaction temperature of 600° C. and the electricity was turned on to the chemical reaction section. The content of nitrogen oxides decreased this time to about 50% when the current density was 44.7 mA/cm² and the power consumption was 97 mW.

### Example 4

An electrical insulation phase 8 composed of porous alumina was formed such that it covered the surface of the reduction phase 4 of the chemical reaction section 3, which was prepared in the same manner as in Example 1. In addition, the chemical reactor (electrochemical cell) was prepared with the catalytic reaction section 2 by forming an LSM film as the oxidation catalyst phase 7 such that the film covered the surface of the electrical insulation phase 8. The cross-sectional structure of this chemical reactor is shown in FIG. 4. The chemical reactor was heated to a reaction temperature of 600° C. and the electricity was turned on to the chemical reaction section. The content of nitrogen oxides decreased this time to about 50% when the current density was 43.3 mA/cm² and the power consumption was 86 mw. when the results were evaluated at a reaction temperature of 550° C., it was found that the content nitrogen oxides had decreased to about 50% when the current density was 43.9 mA/cm²and the power consumption was 130 mW. The results were evaluated at a reaction temperature of 500° C., and it was found that the content of nitrogen oxides had decreased to about 50% when the current density was 45.0 mA/cm² and the power consumption was 220 mW.

### Example 5

A chemical reactor was fabricated in the same manner as in Example 4 except that the reduction phase 4 was a two-layer structure comprising a platinum film and a film composed of a mixture obtained by mixing nickel oxide and zirconia stabilized with scandium oxide in a molar ratio of 6:4. The chemical reactor was heated to a reaction temperature of 600° C. and the electricity was turned on to the chemical reaction section. The content of nitrogen oxides decreased this time to about 50% when the current density was 45.0 mA/cm² and the power consumption was 89 mw.

### Example 6

A chemical reactor was fabricated in the same manner as in Example 4 except that zirconia stabilized with gadolinium oxide was used in the form of a disk with a diameter of 20 mm and a thickness of 0.5 mm as the solid electrolyte 5. The chemical reactor was heated to a reaction temperature of 600° C. and the electricity was turned on to the chemical reaction section. The content of nitrogen oxides decreased this time to about 50% when the current density was 45.2 mA/cm² and the power consumption was 81 mW.

### Comparative Example 1

The chemical reaction section was prepared in the same manner as in Example 1, and this section was used as the chemical reactor without forming a catalytic reaction section. The electricity was turned on in the same manner as in Example 1. The content of nitrogen oxides decreased this time to about 50% when the current density was 94.4 mA/cm² and the power consumption was 310 mW. When the results were evaluated at a reaction temperature of 550° C., it was found that the content of nitrogen oxides had decreased to no more than around 25% at a power consumption of 300 mW.

As described in detail above, the present invention relates to a chemical reactor for carrying out chemical reactions of substances to be treated, such as nitrogen oxides or other substance in oxygen-containing combustion exhaust gases or the like, in the presence of excess oxygen, comprising a chemical reaction section in which the chemical reactions of the substances to be treated proceed, and a catalytic reaction section in which the oxygen concentration is reduced, wherein the catalytic reaction section is disposed in the upstream portion of the chemical reaction section, and the catalytic reaction is utilized to reduce the content of excess oxygen during the chemical reactions. The following kinds of advantageous results are achieved.

(1) It is possible to provide a chemical reactor (electrochemical cell) that can highly efficiently process substances to be treated even in the presence of excess oxygen, which impedes chemical reaction of the substances to be treated.

(2) Since a substance to be treated can be treated highly efficiently, the amount of current required is reduced when the substance to be treated is treated, making it possible to reduce the power consumption of the chemical reactor.

(3) It is possible to provide a new chemical reactor in which nitrogen oxides can be efficiently decomposed or otherwise removed to an environmentally acceptable level by electrochemical reactions in the combined presence of oxygen.

(4) The present invention allows the adsorption sites of gas molecules to be continuously activated in the combined presence of oxygen, so the chemical reactor of the present invention can be combined with other catalytic substances and used as a reactor for decomposing and hydrogen sulfide and other environmental pollutants.

(5) It is possible to provide a reactor capable of efficiently separating oxygen from mixed gases, or a highly efficient oxidation reactor for treating gases, liquids and solids by utilizing the activity of generated oxygen.

What is claimed is:

1. A chemical reactor for carrying out chemical reactions of substances to be treated in the presence of excess oxygen, comprising a chemical reaction section in which the chemical reactions of the substances to be treated proceed, and a catalytic reaction section in which the oxygen concentration is reduced; and having a structure in which the catalytic reaction section is disposed in the upstream portion of the chemical reaction section, wherein the catalytic reaction is utilized to reduce the content of excess oxygen during the chemical reactions.

2. The chemical reactor according to claim 1, wherein the catalytic reaction section comprises an oxidation catalyst.

3. The chemical reactor according to claim 1, wherein the chemical reaction section comprises a reduction phase for supplying electrons to the elements contained in the substances to be treated, to generate ions; an ion-conducting phase for conducting the ions from the reduction phase; and an oxidation phase for releasing the electrons from the ions conducted by the ion-conducting phase.

4. The chemical reactor according to claim 3, wherein the catalytic reaction section covers the surface of the reduction phase.

5. The chemical reactor according to claim 4, wherein a porous oxidation catalyst film covers the surface of the reduction phase.

6. The chemical reactor according to claim 4, wherein an electric insulating layer is disposed between the catalytic reaction section and the reduction phase.

7. The chemical reactor according to claim 3, wherein the substances to be treated are nitrogen oxides, the nitrogen oxides are reduced in the reduction phase to generate oxygen ions, and the oxygen ions are conducted by the ion-conducting phase.

8. The chemical reactor according to claim 1, wherein the oxygen concentration is reduced by means of a catalytic combustion reaction between the oxygen and a combustible gas in the catalytic reaction section.
